(19) United States
(12) Patent Application Publication
(10) Pub. No.: US 2002/0134239 A1
(43) Pub. Date: Sep. 26, 2002

(54) Contaminant removal in enclosed spaces

(76) Inventors: Man-Wing Tang, Cerritos, CA (US); Mark M. Davis, Chicago, IL (US); Syed M. Taqvi, Schaumburg, IL (US); Stephen R. Dunne, Algonquin, IL (US); Peter K. Coughlin, Mundelein, IL (US)

Correspondence Address: JOHN G TOLOMEI, PATENT DEPARTMENT, UOP LLC, 25 EAST ALGONQUIN ROAD, P O BOX 5017, DES PLAINES, IL, 60017-5017, US

(21) Appl. No.: 10/077,302

(22) Filed: Feb. 15, 2002

Related U.S. Application Data
(63) Continuation-in-part of application No. 09/731,404, filed on Dec. 6, 2000.

(51) Int. Cl. B01D 53/02; B01D 59/26; B32B 5/00

(52) U.S. Cl. 95/90; 95/117

(57) ABSTRACT

The present invention relates to a process for maintaining the humidity of an enclosed space within an acceptable operational range of relative humidity to minimize static electricity while passively removing at least a portion of organic contaminants from the enclosed space. The invention provides a simple, low cost solution to preventing damage to electronic disk drives using an adsorbent sheet material which requires less than about one-tenth the volume of adsorbent carriers which enclose the adsorbent material in a supporting envelope. The process employs a weak adsorbent such as high silica zeolite which effectively controls humidity at low operating temperatures and as the operating temperature increases is enabled to adsorb contaminants by reduced affinity for water.

### CROSS-REFERENCE TO RELATED APPLICATION

This application is a Continuation-in-Part of copending application Ser. No. 09/731,404 filed Dec. 6, 2000, the contents of which are hereby incorporated by reference.

### FIELD OF THE INVENTION

This invention relates to a method for removing contaminants from enclosed spaces. More particularly, the present invention relates to the use of an adsorbent carrier disposed in an enclosed space to adsorb contaminants.

### BACKGROUND OF THE INVENTION

Many enclosures that contain sensitive instrumentation must maintain very clean environments in order to keep that instrumentation running properly. Examples include enclosures with sensitive optical surfaces, electronic connections and magnetic data storage surfaces on computer hard disk drives. Contaminants to these surfaces may be either particulate or gaseous in nature insomuch as they interfere with the proper operation of the equipment, and may enter the enclosure from the outside environment or be generated within the enclosure such as by outgassing of components. The adverse effects of many of these contaminants are well known and are disclosed in an article entitled, “The Effect of Vapor Phase Chemicals on Head/Disk Interface Tribology”, by Mark S. Jesh and Peter R. Segar, presented at the Society of Tribologists and Lubrication Engineers, Oct. 26-28, 1988, and hereby incorporated by reference.

Filtration devices to keep particulate from entering these enclosures are well known. They may consist of a filtration media held in place by a housing of polycarbonate, acrylonitrile butadiene styrene, or some other material; or they may consist of a filtration media in the form of a self-adhesive disk utilizing a layer or layers of pressure sensitive adhesive. These devices are mounted and sealed over a vent hole in the enclosure to filter the air entering the enclosure. Filtration performance depends not only on the filter having a high filtration efficiency but also on having a low resistance to air flow so that unfiltered air does not leak into the enclosure through a gasket or seam instead of entering through the filter.

Cartridges that contain adsorbents or reactants to remove gas or vapor impurities are also well known. They may consist of an adsorbent material held in place by a housing of polycarbonate, acrylonitrile butadiene styrene, or other material which also utilizes a filtration media that allows the exchange of gases in and out of the adsorbent cartridge while preventing the adsorbent material from becoming a source of particulate contamination. A preferred configuration of the adsorbent cartridge is to have the adsorbent completely encapsulated by the filtration media such as in a tube of pure expanded polytetrafluoroethylene as described in U.S. Pat. No. 4,830,643 B1. Another example is U.S. Pat. No. 6,214,095 B1 which relates to a pouch of adsorbent material for removing gaseous contaminants and impurities from a disk drive enclosure by disposing a mechanically mounted pouch having a non-adhesive filter layer disposed over and peripherally sealed around the adsorbent layer in the internal enclosure of a disk drive.

Another constraint, however, in many enclosures is space. The sensitive instrumentation is continually being miniaturized and put in smaller and smaller enclosures. In some cases this compounds the contamination problem as surfaces become more sensitive and closer together such as in computer hard disk drives where particulates, hydrocarbon gases, acid gases and solvent vapors become more of a problem as read/write head flying heights become smaller and more sensitive higher density thin film recording media are employed.

Breather filters that are constructed of only filter media and a self-stick adhesive are ideal for these applications as they can be made very thin and small in size. Adsorbent cartridges or tubes, however, take up valuable space in these enclosures, and when they are used, they often must be put into a corner away from the most sensitive surfaces because of space constraints.

One solution of these problems is the combination of an adsorber breather filter. These can be made by filling a cartridge of polycarbonate, acrylonitrile butadiene styrene, or some other material with adsorbent and securing filter media on both ends of the cartridge and attaching said cartridge to the enclosure which needs a controlled environment. This allows air to enter the enclosure through the adsorbent to clean the air that enters the enclosure. Gas or vapor contaminants that outgas or originate from sources inside the enclosure can be captured by the adsorbent by diffusing through the filter media into the adsorbent material. These cartridges also take up space although they can be mounted outside the enclosure. Outside mounting, however, raises problems of rigidity and sturdiness as a filter that protrudes from the enclosure is subject to easier damage.

A second contamination adsorbent breather filter is also available that encapsulates the adsorbent material between two layers of filter media and is applied to the enclosure with a layer of self-stick adhesive.

Both of these above-mentioned adsorbent breather configurations, however, have two major drawbacks. First, since they utilize two layers of filter media and a layer of adsorbent material, they suffer from a fairly high resistance to air flow. As mentioned earlier, filtration performance in a breather filter depends in part upon the filter having a low resistance to air flow such that unfiltered air is not forced or allowed to leak through gaskets or seams that might open up under higher pressure. Secondly, since they are located directly under or over a vent hole into the enclosure, one side of the adsorbent breather faces the outside atmosphere and the adsorbent can become more quickly spent or saturated with gaseous contaminants.

There is a need for a system that minimizes space requirements for adsorbent, and has a long lasting adsorbent that is easily mounted proximate to the critical areas of enclosures housing sensitive instrumentation.

### SUMMARY OF THE INVENTION

This invention provides a method for using an adsorbent disposed in an adsorbent carrier having a low profile for selectively adsorbing gaseous components from an enclosed space. More particularly, the present invention provides a simple, low profile solution to controlling the humidity and contaminants within the enclosed space of a disk drive. The adsorbent sheet of the present invention occupies one-tenth of the volume of previous methods of suspending adsorbent material in disk drive enclosures and recognizes the need for a weak adsorbent which maintains the relative humidity within a range of about 30 to about 70 percent relative to ambient or room temperature to avoid static electricity formation at the low end and avoid condensation of liquid water at the high end of the humidity range. Furthermore, the adsorbent sheet of the present invention using a specific group of adsorbents known as high silica zeolites permits both the adsorption of water to the degree necessary for the operation of the disk drive while still providing for the adsorption of harmful organic solvents such a benzothiozole. Still further, the high silica zeolites of the present invention provide a temperature responsive selectivity which permits the passive regulation of the humidity of the enclosed space of the disk drive at up to relatively modest temperatures. As the temperature within the enclosed space of the disk drive increases while the partial pressure of the water in the enclosed space is fixed, the relative humidity in the enclosed space is reduced and the capacity of the high silica adsorbent for the adsorption of contaminants is enhanced relative to the capacity of the high silica adsorbent for adsorbing contaminants at ambient or room temperature. This is particularly useful because more contaminants including organic solvents and related impurities are evolved at the higher operating temperatures.

The adsorbent sheet of the present invention provides a means for continually depleting the air of unwanted contaminating gases in an enclosure by providing a means for adsorbing these unwanted gases by permitting the adsorbent carriers to be placed proximate to the critical areas that require protection with a significant volume reduction over prior attempts to solve this problem.

The present invention provides a process for the passive removal of a contaminant from a gas comprising water and the contaminant in an enclosed space, wherein the process comprises contacting the gas with a uniform adsorbent sheet comprising a weak adsorbent to maintain effective gas quality within the enclosed space. The invention further provides a process for the passive regulation of water and a contaminant from a gas comprising water and the organic contaminants in an enclosed space, said process comprising contacting the gas with an adsorbent sheet having an asymmetric structure containing a weak adsorbent to provide a relative humidity ranging from about 30 to about 70 percent over a temperature within the enclosed space ranging from about 20° to about 50° C. and to remove about 55 to about 90 percent of the contaminant.

Additional objects, embodiments and details of this invention can be obtained from the following detailed description of the invention.

### DETAILED DESCRIPTION OF THE INVENTION

The present invention provides a very thin adsorbent assembly that is disposed within the interior enclosure of a computer disk drive and that is capable of removing contaminants within the enclosure. Because of the novel features of the assembly, specifically its thin dimensions, its humidity control features, and its enhanced contaminant adsorption properties during the operation of the disk drive, contaminants are easily removed with minimal interference in the operation of the disk drive. In a further aspect of the invention, the asymmetric structure of the adsorbent material disposes the adsorbent in close proximity to the active surface of the disk drive to provide the maximum benefit. In a still further embodiment, the adsorbent assembly can be layered to provide multiple functionality.

According to the present invention, flat sheet adsorption materials are disposed in enclosed space of a disk drive housing to remove contaminants. The flat sheet adsorbent material may comprise either uniform structure wherein the adsorbent material and a binder are evenly distributed throughout the binder forming a uniform layer, or wherein the adsorbent material is distributed in an asymmetric binder structure in a uniform layer wherein the adsorbent material comprises an adsorbent face and a binder face opposite. Examples of an adsorbent material with a uniform structure are disclosed in U.S. Pat. No. 6,130,263 B1 and U.S. Pat. No. 5,911,937 B1 which disclose a method for the preparation of moisture absorbing desiccant entrained polymers. These patents disclose how the polymer can inhibit the desiccant properties of the adsorbent and how the polymer acts as a moisture barrier which can prevent the desiccant agent from coming into contact with the gas to be treated. Processes are disclosed in U.S. Pat. No. 6,130,263 B1 for the blending of a channeling agent into the molten polymer at the time the desiccant agent is added to the polymer such that the channeling agent forms passages in the mixture through which moisture can reach the entrained desiccating agent after the molten polymer is re-solidified. Another example of a uniform adsorbent sheet which comprises an adsorbent paper layer for use in desiccant and dehumidification processes is disclosed in U.S. Pat. No. 5,650,221 B1. The adsorbent paper layer of U.S. Pat. No. 5,650,221 B1 is comprised of an improved support material, fibrous material, binders, and high levels of desiccant or adsorbent material. The fibrous material include cellulosic fibers, synthetic fibers and mixtures thereof. Fibrillated fibers, that is, fiber shafts which are split at their ends to form fibrils, i.e., fine fibers or filaments much finer than the fiber shafts are incorporated into the paper to overcome the low adhering problem of the zeolites by trapping the zeolite powder within the fibrillated fibers. Examples of fibrillated, synthetic organic fibers useful in the adsorbent paper disclosed are fibrillated aramid and acrylic fibers. An example of such a fiber is available from E.I. du Pont de Nemours & Company under the designation KEVLAR®. The desiccant or adsorbent may be incorporated in the paper during fabrication of the paper, or the paper may be formed and the desiccant or adsorbent coated, or a combination of adsorbent incorporation during paper making and coating with adsorbent thereafter. The adsorbent paper has a thickness of from about 5 mils (0.13 mm) to about 20 mils (0.5 mm) and comprises at least 50 percent adsorbent.

The flat sheet adsorption materials which have an asymmetric structure can be produced in a uniform layer by means of immersion precipitation of a molecular sieve/polymer solution. The flat sheet adsorption materials are placed in an enclosed spaced to remove contaminants. The asymmetric structure of the flat sheet adsorbent provides an adsorbent sheet which has one side comprising a dense polymer surface and a reverse side comprising a dense adsorbent surface. The flat sheet material having an asymmetric structure which can be employed in the present invention can comprise up to about 86 weight percent of an adsorbent such as a zeolite molecular sieve while still retaining sufficient flexibility for the flat sheet material. The flat sheet adsorbents of the present invention have a dense polymer side which can easily be bonded to smooth surfaces such as aluminum, glass, or stainless steel and the like, to provide an exposed stable adsorbent surface for use in the sorption or desiccant processes.

The adsorbent material can be formed into a single layer comprising a single adsorbent or the adsorbent can comprise multiple layers with varying amounts of the same or different adsorbents as disclosed in U.S. Pat. No. 5,702,503 B1 which is hereby incorporated by reference. The adsorbent material formed from multiple layers will have improved structural integrity over a single layer material and can be formed into a greater range of thicknesses. By the term “structural integrity”, it is meant that the potential for dusting of the adsorbent is induced by disposing the adsorbent in multiple layers. A multiple structure would further provide greater control of the porosity of the adsorbent material for those applications where the adsorbent material will also function as a filter media. Furthermore, the solubility properties of the polymer binder can be employed to supplement the adsorption properties of the adsorbent material. For example if a hydrophobic polymer is used in a dense polymer surface, then the amount of water reaching the underlying dense adsorbent surface will be limited. This allows a hydrophilic adsorbent such as 13X to be used in the underlying dense adsorbent surface without concern for how water might compete with the desired adsorbate for sites on this underlying layer. In a multiple layer adsorbent material, a layer of 13X bound with polysulfone, can be covered with a layer of silicalite bound with polystyrene. The silicalite can control the humidity to the desired level, and adsorb some of the organic contaminants. Because the hydrophobic polystyrene layer will retard water from reaching the 13X, the 13X can adsorb more of the organic components without adsorbing a significant amount of water.

The adsorbent material may include physisorbents, such as silica gel, activated carbon, activated alumina, or molecular sieve, or chemisorbents, such as potassium permanganate, calcium carbonate, calcium sulfate, powdered metals or other reactants for scavenging gas phase contaminants depending on the known contaminants desired to be removed. In addition, the adsorbent material may be a mixture of the above-mentioned materials.

Multiple layers of adsorbent materials may be used in the flat adsorbent material. The structural integrity of the adsorbent material sheet might be superior if the adsorbent is applied as separate layers rather than as one thick layer. In addition, the use of multi-layer sheets provides for improved adsorbent performance. A dense polymer surface of a first adsorbent layer can physically block the dense adsorbent surface of a second adsorbent layer on which the first layer is disposed. The porosity of the dense polymer in the first adsorbent layer can be controlled such that if the porosity of the dense polymer in the first adsorbent layer is low, then the solubility of the adsorbate in the dense polymer layer can influence or control the mass transfer to the second adsorbent layer. In this manner, the solubility properties of the polymer can be used to supplement the adsorption properties of the adsorbent. Furthermore, each layer can contain a different adsorbent to selectively remove contaminants as the contaminants pass through the different adsorbent layers of the flat sheet adsorbent material. For example, if a hydrophobic polymer is used in the first adsorbent layer, the mass transfer of water to the second layer is limited by the hydrophobic polymer surface, and water reaching the second adsorbent layer is reduced. With the potential for the introduction of water to the second, or underlying adsorbent layer, a hydrophilic adsorbent such as 13X zeolite can to be used in the second adsorbent layer to remove contaminants. In this manner the reduced amount of water reaching the second adsorbent layer will be less likely to compete with the contaminants for sites on the adsorbent in the second adsorbent layer. One example of such a multiple layer adsorbent material comprises a second layer of 13X zeolite bound with polysulfone, having an outer or first layer of a high silica zeolite such as silicalite bound with polystyrene. The silicalite can control the humidity to the desire level, and adsorb some of the organic contaminants. Because the hydrophobic polystyrene layer will retard at least a portion of the water in the enclosed disk drive space from reaching the 13X zeolite bound in the second, or underlying layer permitting the 13 X zeolite to adsorb more of the contaminants without competing with the potentially larger amount of water in the enclosed space.

The molecular sieves include zeolitic molecular sieves. Zeolitic molecular sieves in the calcined form may be represented by the general formula:

Me_{2/n}O:Al₂O₃:xSiO₂

where Me is a cation, x has a value from about 2 to infinity and n is the cation valence. High silica zeolites which may be used include: clinoptilolite, boggsite, EMC-2, zeolite L, ZSM-5, ZSM-11, ZSM-18, ZSM-57, EU-1, offretite, faujasite, ferrierite, mordenite, zeolite Beta, and silicalite. The adsorbent of the present invention will be selected from high silica zeolite adsorbents and mixtures thereof. It is desirable to reduce the aluminum content in the zeolite framework or structure, thereby reducing the affinity of water to the zeolite while retaining its ability to retain its hydrocarbon adsorption capacity in the presence of fairly high moisture levels. For these reasons, zeolites suitable for use according to the present invention are those having a high silica content, i.e., those having framework silica-to-alumina ratios preferably greater than 15. The term “framework silica-to-alumina ratio” refers only to the aluminum and silicon atoms which are tetrahedrally coordinated within the zeolite structure. Preferably, adsorbents which are naturally occurring or are synthetically produced with a framework silica-to-alumina ratio less than about 15 will be modified by conventional means such as steaming, acid extraction, fluoride treatment and the like to increase the framework silica-to-alumina ratio to greater than about 15. Faujasites having a framework silica-to-alumina ratio greater than 15 are preferred for use with the present invention. The preferred adsorbents for use with the present invention include synthetic and naturally occurring zeolites with a framework silica-to-alumina ratio greater than 15 and having a pore opening of at least about 6.0 angstroms and, preferably, larger than about 6.2 angstroms. More particularly, synthetic and naturally occurring zeolites having a FAU structure as defined in the “Atlas of Zeolite Structure Types,” by W. M. Meier and D. H. Olson, issued by the Structure Commission of the International Zeolite association, (1987), on pages 53-54 and pages 91-92, are preferred. The above reference is hereby incorporated by reference. Detailed descriptions of some of the above-identified zeolites may be found in D. W. Breck, Zeolite Molecular Sieves, John Wiley and Sons, New York, 1974, hereby incorporated by reference.

Adsorbents suitable for the process of the present invention may comprise Zeolite Y or various modifications of Zeolite Y in a refractory inorganic oxide matrix. Zeolite Y can be modified for example by increasing the molar ratio of silica to alumina. U.S. Pat. No. 4,869,803 B1 describes an improved method of calcining zeolites. This patent presents characterizations of Y-82, LZ-10 and LZ-20 zeolites in columns 7-8 and is incorporated herein by reference for its teaching regarding the preparation, characterization and distinguishing features of each of these materials. This reference refers to U.S. Pat. No. 4,401,556 B1 disclosing an ultrahydrophobic Zeolite Y (UHP-Y) characterized by having a silica-to-alumina molar ratio of from 4.5 to 35, the essential X-ray powder diffraction pattern of zeolite Y, an ion exchange capacity of not greater than 0.070, a unit cell dimension of from 24.20 to 24.45 angstroms, a surface area of at least 350 m²/g (B-E-T), a sorptive capacity for water vapor at 25° C. of from 2 to 4 weight percent at a p/p^{o} value of 0.10 and a Residual Butanol Test value of not more than 0.40 weight percent. This reference has been referred to in the art as describing the preparation of the zeolite sold under the LZ-10 trademark. LZ-20 is prepared in a similar manner to LZ-10, except that the final calcination takes place in a single step. Zeolite LZ-15 is prepared in a similar manner as zeolite LZ-20, but LZ-15 has a lower water capacity than zeolite LZ-20. The specifications for LZ-20 are a SiO₂/Al₂O₃ ratio of 5.0 to 6.0 (by bulk chemical analysis), a surface area of from 580 to 650 m²/g (B-E-T), a unit cell dimension of from 24.33 to 24.41 angstroms and a sorptive capacity for water vapor of from 3.0 to 5.5 pounds of water per 100 pounds of adsorbent. Zeolites LZ-10, LZ-20 and LZ-15 are available from UOP LLC in Des Plaines, Ill. The framework silica-to-alumina ratios for these high silica zeolites are as follows:

| ZEOLITE | Framework Silica-to-Alumina Ratio |
|---|---|
| LZ-10 | 30-60 |
| LZ-15 | 28-66 |
| LZ-20 | 13-22 |

The adsorbent layer of the present invention can comprise a cellulosic or a polymeric material to support and bind the adsorbent. The membrane substrate of the present invention includes cellulosic membranes and membranes formed from other polymers such as polysulfone, polyethersulfone, polyamide, polyimide, polyetherimide, cellulose nitrate, polyurethane, polycarbonate, polystyrene, etc. The term “cellulosic membrane” in the context of the instant invention includes cellulose ester membranes such as cellulose acetate, cellulose diacetate, cellulose triacetate, cellulose propionate, cellulose butyrate, cellulose cyanoethylate, cellulose methacrylate and mixtures thereof. These membranes may be flat film or hollow fiber. Particularly preferred membrane layers comprise cellulose acetate or polysulfone. Surprisingly, the adsorbent layer of the present invention can be produced with a loading of between about 50 to about 86 weight percent solid adsorbent to produce an essentially uniform layer in an asymmetric structure containing a uniform distribution of adsorbent material with essentially no loss of valuable solid adsorbent. Methods of producing similar adsorbent loading by traditional paper making or felting operations resulted in the production of layers with uneven distribution of adsorbent and with significant losses of up to about 50 weight percent of the solid adsorbent during the manufacturing process. In addition, the adsorbent sheet of the present invention was found to be more flexible and have a more uniform and smooth appearance than materials produced either by impregnating paper or incorporating adsorbent materials into the paper during the paper making process. The thus formed asymmetric adsorbent sheets can be disposed in the disk drive enclosure and used to dehumidify and remove potentially harmful organic compounds from the enclosed space.

Surprisingly, the adsorbent sheet of the present can place an effective amount of adsorbent within a disk drive enclosure and provide a 10-fold decrease in volume over adsorbent envelops which are in current use. Using a high silica zeolite adsorbent, this now significantly smaller device provides both humidity control within the disk drive enclosure and in addition it still capable of adsorbing, or removing benzothiozole, one of the organic compounds which is known to cause damage to the disk drive. The adsorbent sheet of the present invention was found to be capable of removing from about 60 to about 90 percent of the benzothiozole present in an enclosed space over a relative humidity of the air in the enclosed space ranging from about 30 to about 65 percent within the enclosed space. The adsorbent sheet of the present invention can be employed in any closed or semi-closed chamber where humidity control and removal of organic compounds is required.

The use of high silica zeolites provides the adsorbent material with a mild adsorbent for humidity control. Over the lower range of temperature in the enclosed space of the disk drive, the relatively is passively controlled within the range of about 30 to about 65 percent relative humidity. As the temperature of the enclosed space ranges from about 25° to about 75° C. Without being bound by any particular theory, it is believed that the high silica zeolites adsorb the majority of the water vapor at the lower range of the temperature. As the temperature in the enclosed space increases, some water is desorbed. Because the adsorption water competes with the adsorption of any organic solvents and other impurities, at the higher operating temperature, the high silica zeolite now has a greater capacity for the organic solvents and other impurities. Thus, the high silica zeolites are ideally suited for this passive regulation of humidity and solvent removal from enclosed spaces, particularly where the solvents and impurities are more likely to be evolved at the higher operating temperatures.

In a further embodiment of the invention, the porosity of the polymer binder of the adsorbent sheet can be controlled to provide an open framework to permit the use of the flat sheet adsorbent material as both an adsorbent device and a particulate filter media. By containing the adsorbent in an open polymer matrix, the need for a pouch to support the adsorbent is eliminated by positioning at least a portion of the flat sheet adsorbent material over the vents to filter any gas entering the enclosed space from the surrounding space.

Computer disk dives represent one example of a closed or semi-closed application. Other applications include disposing the adsorbent sheet of the present invention in instrument enclosures, electrical enclosures, display cases and document frames where moisture and organic solvent could adversely impact the contents of the enclosures.

The adsorbent sheets of the present invention can be bonded by any bonding means including mechanical fasteners or adhesives to the active sorption surfaces which come into contact with the fluid being sorbed. The bonding means employed to secure the adsorbent sheets of the present invention in electrical enclosures includes any conventional means to shield any electromagnetic interference or minimize or eliminate the buildup of static electricity

The invention is further illustrated by the following examples which are illustrative of specific modes of practicing the invention and are not intended as limiting the scope of the invention defined in the claims.

### EXAMPLES

### Example I

Size Comparison

A typical enclosed space in a disk drive comprises an envelope which is roughly rectangular having a length of about 105 mm, a width of about 70 mm and a depth of about 20 mm resulting in a total volume of the enclosed space of about 150 cubic centimeters. The water in the enclosed space for a disk drive constructed at ambient conditions of 100 percent relative humidity at an ambient temperature of 30° C. is equivalent to a water partial pressure in the enclosed space of 31.6 torr, or a water concentration of about 3×10⁻⁵ g/cc. Accordingly, a silica gel adsorbent disposed in an adsorbent assembly as disclosed in U.S. Pat. No. 5,593,482 B1 requires about 0.0884 cubic centimeters if adsorbent and has a minimum total thickness of about 41 mm, having a total package volume to be disposed within the enclosed space of about 4.9 cubic centimeters. The same amount of silica gel adsorbent disposed in a 1 mm (28 mil) thickness adsorbent sheet of the present invention has a total package volume of about 0.46 cubic centimeters. Surprisingly, the same amount of adsorbent disposed in the adsorbent sheet of the present invention represents a ten-fold reduction in the total volume of the desiccant carrier compared to an adsorbent assembly having an adsorbent layer surrounded by additional outer layers.

### Example II

One harmful organic species which must be adsorbed in the enclosed space of a disk drive is benzothiozole. The presence of benzothiozole in the enclosed space of a disk dive can result in damage to the memory integrity of the disk drive. At a temperature of about 26° C. exhibited, the adsorption isotherm data shown in Table 1 for adsorption at atmospheric pressure over the adsorbent sheet of the present invention containing a high silica zeolite. The adsorption isotherm was determined in a conventional manner on an adsorbent sheet having a thickness of about 1 mm in thickness.

TABLE 1
Adsorption of Benzothiozole

| Partial Pressure, torr | Loading, wt- % |
|---|---|
| 0.0117 | 0.41 |
| 0.0241 | 0.64 |
| 0.0464 | 0.79 |
| 0.0743 | 0.91 |
| 0.0985 | 1.04 |

### Example III

Water isotherms were developed in a conventional manner for a 1 mm (28 mil) thickness adsorbent sheet of the present invention containing a high silica zeolite adsorbent (HiSiv 1000, available from UOP LLC, in Des Plaines, Ill.). The water isotherms of the adsorbent were developed at 22.5° and 51° C. and are shown in Table 2 in terms of grams of water per 100 grams of dry molecular sieve as a function of the partial pressure of water in torr. As the temperature of the adsorption is increased to the higher temperature, the water loading is clearly reduced at the same water partial pressure.

TABLE 2
Water Isotherm on High Silica Zeolite

Water, g/100 g

| Partial Pressure, torr | Loading at 22.5° C. | Loading at 51° C. |
|---|---|---|
| 7 | 2.9 | 1.5 |
| 15.2 | 6.2 | 2.7 |

### Example IV

The adsorption of an organic solvent, benzothiozole which is known to be harmful to magnetic disk surfaces was determined on the activated and hydrated cast film adsorbent material of the present invention containing a high silica zeolite of Example III. The adsorbent material was activated by heating to a temperature of about 29° C. in a conventional manner and partially hydrated prior to exposure to the organic solvent to simulate conditions within the enclosed space of a disk drive. Table 3 shows the adsorption of benzothiozole as a function its partial pressure expressed in torr at (a) 2.5 weight percent, (b) 3.8 weight percent and (c) 5 weight percent water loading on the adsorbent material.

TABLE 3
Benzothiozole Adsorption on Hydrated Adsorbent

| Partial | Benzothiozole Loading, wt- % | | |
|---|---|---|---|
| Pressure, torr | (a) | (b) | (c) |
| 0.04 | 0.30 | 0.24 | 0.10 |
| 0.06 | 0.46 | 0.37 | 0.25 |
| 0.08 | 0.60 | 0.45 | 0.40 |
| 0.1 | 0.73 | 0.52 | 0.45 |
| 0.14 | 0.9 | 0.54 | 0.48 |

By comparison, without pre-hydration, the adsorption of benzothiozole on the high silica zeolite adsorbent material ranged from a loading of about 0.9 weight percent to about 1.3 weight percent over a partial pressure range of 0.04 to 0.14 torr at about 25° C.

What is claimed is:

1. A process for the passive removal of a contaminant from a gas comprising water and the contaminant in an enclosed space, said process comprising contacting the gas with a uniform adsorbent sheet comprising a weak adsorbent to maintain effective gas quality within the enclosed space.

2. The process of claim 1 wherein the weak adsorbent is selected from the group consisting of silica gel, molecular sieves, activated aluminas, activated carbon and combinations thereof.

3. The process of claim 1 wherein the weak adsorbent comprises a high silica zeolite.

4. The process of claim 1 wherein the weak adsorbent is selected from the group consisting of clinoptilolite, boggsite, EMC-2, zeolite L, ZSM-5, ZSM-11, ZSM-18, ZSM-57, EU-1, offretite, faujasite, ferrierite, mordenite, zeolite Beta, and silicalite

5. The process of claim 1 wherein the weak adsorbent has a silica to alumina ratio greater than 10:1.

6. The process of claim 1 wherein the weak adsorbent comprises silicalite.

7. The process of claim 1 wherein the effective gas quality within the enclosed space includes a relative humidity between about 30 and about 70 percent.

8. The process of claim 1 wherein between about 50 to about 90 weight percent of the organic contaminants are removed from the gas.

9. The process of claim 1 wherein the enclosed space is defined by a housing surrounding a disk drive.

10. The process of claim 1 wherein the uniform adsorbent sheet has an asymmetric structure.

11. The process of claim 1 wherein the uniform adsorbent sheet is disposed in multiple layers.

12. The process of claim 1 wherein the uniform adsorbent sheet comprises a hydrophobic polymer binder.

13. The process of claim 1 wherein the uniform adsorbent sheet comprises a hydrophobic polymer binder and a hydrophilic adsorbent.

14. The process of claim 13 wherein the hydrophobic polymer binder comprises polysulfone and the hydrophilic adsorbent comprises 13X zeolite.

15. The process of claim 13 wherein the adsorbent material comprises a first layer consisting of a hydrophobic polymer and a hydrophilic adsorbent and at least one other layer consisting of a hydrophobic polymer and a hydrophilic or a hydrophobic adsorbent.

16. The process of claim 1 wherein the contaminant is selected from the group consisting of chlorine, hydrogen sulfide, nitrous oxide, mineral acids, silicone vapors, alcohols, ketones, hydrocarbons, and mixtures thereof.

17. The process of claim 1 wherein the contaminant comprises benzothiozole.

18. The process of claim 1 wherein the uniform adsorbent sheet is disposed as a filter media.

19. A disk drive using a passive humidity control and contaminant removal system according to the process of claim 1.

20. A process for the passive regulation of water and a contaminant from a gas comprising water and the organic contaminants in an enclosed space, said process comprising contacting the gas with an adsorbent sheet having an asymmetric structure containing a weak adsorbent to provide a relative humidity ranging from about 30 to about 70 percent over a temperature within the enclosed space ranging from about 20° to about 50° C. and to remove about 55 to about 90 percent of the contaminant.
